(19) United States
(12) Patent Application Publication
(10) Pub. No.: US 2002/0108124 A1
(43) Pub. Date: Aug. 8, 2002

(54) Method of and apparatus for broadcasting programs, method of and apparatus for receiving programs, and computer product

(76) Inventor: Keiji Sato, Nagoya (JP)

Correspondence Address: STAAS & HALSEY LLP, 700 11TH STREET, NW, SUITE 500, WASHINGTON, DC, 20001, US

(21) Appl. No.: 09/883,238

(22) Filed: Jun. 19, 2001

(30) Foreign Application Priority Data
Feb. 7, 2001 (JP) 2001-31581

(51) Int. Cl. H04N 7/16; H04N 7/025; H04N 7/10; G06F 17/60; G06F 3/00; H04N 5/445; G06F 13/00

(52) U.S. Cl. 725/136; 725/60; 725/139; 705/37

(57) ABSTRACT

The broadcasting unit extracts an object displayed onto the display screen of a program to be broadcasted from the program information about programs, generates the relevant information about the extracted object, generates the sync information for synchronizing the program information with the relevant information, and transmits the program information, relevant information, and sync information to a receiving unit. The receiving unit stores the received information and synchronously outputs the program information and relevant information in accordance with the stored sync information.

### FIELD OF THE INVENTION

The present invention relates to a technology of broadcasting or receiving programs.

### BACKGROUND OF THE INVENTION

A digital broadcasting system for transmitting program information and advertisement information by multiplexing the advertisement information on the program information has been used so far in a digital broadcasting station. For example, the broadcast receiver disclosed in the Japanese Patent Application Laid-Open No. 2000-253355 receives and stores the advertisement data transmitted from a broadcasting station and when a user designates display of an advertisement, audience can select desired information out of the advertisement data and confirm the data according to necessity by reading the stored advertisement data and display the data on a display unit.

Moreover, the receiver disclosed in the Japanese Patent Application Laid-Open No. 11-17633 receives the advertisement information to which a target ID for identifying the audience purposed by a commodity to be advertised is added from a broadcasting station, collates audience attribute previously entered in an IC card with the target ID, and selectively confirms the advertisement information.

However, a conventional digital broadcasting system has a problem that it is impossible to organically combine a program with an advertisement and provide the program and simultaneously display the relevant advertisement.

That is, the receiver disclosed in the Japanese Patent Application Laid-Open No. 2000-253355 confirms advertisement data by selecting necessary advertisement data according to necessity but it has a problem that audience cannot properly select and display a relevant advertisement when a program and an advertisement have a close relation and an advertisement object in a program is displayed.

Moreover, the broadcasting system disclosed in the Japanese Patent Application Laid-Open No. 11-17633 adds a target ID for identifying the audience purposed by a commodity advertised by a broadcasting station to advertisement information but it does not add the information about the relation between an advertisement and a program (for example, the fact that a commodity and the like to be advertised is a commodity and the like appearing in a program) Therefore, when a program and an advertisement have a close relation, it is impossible to properly select and display advertisement information.

Moreover, there is no conventional broadcasting system in which a sponsor can be contracted for a commodity and the like appearing in a program to be broadcasted.

Thus, the conventional system has many problems and therefore, it is inconvenient for digital-broadcast audience and advertisement providers and moreover, the system has a low advertisement rate.

The prior art and problems to be solved by the invention can be considered not only for a digital broadcasting system using a communication satellite (CS) or broadcasting satellite (BS) but also for all systems capable of multiplexing and transmitting advertisement information and broadcast information such as ground-wave broadcast and Internet broadcast.

### SUMMARY OF THE INVENTION

It is an object of this invention to provide a technology capable of organically combining a program with an advertisement, and providing a program and simultaneously displaying a relevant advertisement.

It is another object of this invention to provide a technology capable of efficiently recruiting a sponsor for a commodity and the like appearing in a program.

According to one aspect of this invention, the broadcasting unit extracts an object that has been displayed onto the display screen of a program from the program information about programs, generates the relevant information about the extracted object, generates sync information to be used for synchronizing the program information with the relevant information, and transmits the program information, relevant information, and sync information to a receiving unit.

According to another aspect of this invention, the broadcasting unit extracts an object displayed onto the display screen of a program from the program information about programs, generates the sponsor-recruiting information for recruiting a sponsor for the extracted object, and transmits the program information and the sponsor-recruiting information to the receiving unit.

According to still another aspect of this invention, the receiving unit receives the sync information for synchronizing the program information about a program to be broadcasted, relevant information about an object displayed onto the display screen of the program, and sync information for synchronizing the program information with the relevant information, stores the program information, relevant information, and sync information received by said information receiving unit, and synchronously outputs the program information and relevant information in accordance with the stored sync information.

According to still another aspect of this invention, the receiving unit receives the program information about a program to be broadcasted and sponsor-recruiting information for recruiting a sponsor for an object displayed onto the display screen of the program, stores the program information and sponsor-recruiting information, outputs the stored program information and sponsor-recruiting information, and transmits a sponsor-designating information for designating that the sponsor becomes a sponsor for the object to the broadcasting unit.

The term “object” denotes a commodity, building, person, or scene appearing in a program.

Other objects and features of this invention will become apparent from the following description with reference to the accompanying drawings.

### BRIEF DESCRIPTION OF THE DRAWINGS

FIG. 1 is a block diagram showing a general configuration of the present system;

FIG. 2 is a block diagram showing a configuration of broadcasting unit 100 to which the present invention is applied;

FIG. 3 is a block diagram showing a configuration of a receiver 200 to which the present invention is applied;

FIG. 4 is a flowchart showing an example of transmission processing by the broadcasting unit of the present system of this embodiment;

FIG. 5 is an illustration showing a concept of an object extraction table stored in a storage section 106 of the broadcasting unit 100;

FIG. 6 is an illustration showing a concept of a sync-information management table 106c stored in the storage section 106 of the broadcasting unit 100;

FIG. 7 is a flowchart showing an example of output processing of program information and relevant information in the receiver of the present system of this embodiment;

FIG. 8 is an illustration showing the display screen of a relevant-information-selecting window displayed on the monitor of the receiver 200;

FIG. 9 is an illustration showing the display screen of a relevant-information-selecting window and an example of the information for designating the display position of an object displayed on the monitor of the receiver 200;

FIG. 10 is an illustration showing display screens of a relevant-information-selecting window and a detail-information window displayed on the monitor of the receiver 200;

FIG. 11 is a flowchart showing an example of auction processing by the present system of this embodiment;

FIG. 12 is an illustration showing the display screen of a relevant-information-selecting window displayed on the monitor of the receiver 200;

FIG. 13 is an illustration showing the display screen of a relevant-information-selecting window an example of the information for designating the display position of an object displayed on the monitor of the receiver 200;

FIG. 14 is an illustration showing display screens of a relevant-information-selecting window and a detail-information window displayed on the monitor of the receiver 200;

FIG. 15 is an illustration showing a successful-bidder display screen displayed on the monitor of the receiver 200;

FIG. 16 is a block diagram showing a configuration of the receiver 200 of a sponsor to which the present invention is applied;

FIG. 17 is a flowchart showing an example of sponsor-recruitment processing by the present system of this embodiment;

FIG. 18 is an illustration showing a display screen of a sponsor-recruiting-information display window displayed on the monitor of the receiver 200; and

FIG. 19 is an illustration showing a sponsor-recruiting-information display window and a display screen of the information for designating the display position of an object displayed on the monitor of the receiver 200.

### DESCRIPTION OF THE PREFERRED EMBODIMENTS

Preferred embodiments of the present invention will be described below by referring to the accompanying drawings. However, the present invent is not limited only to these embodiments.

Particularly, for the following embodiments, cases are described in which the present invention is applied to a digital broadcasting system using a communication satellite (CS) or a broadcasting satellite (BS) and Internet broadcasting. However, the present invention can be applied not only to the above cases but also to every broadcasting system capable of multiplexing and transmitting advertisement information and broadcast information.

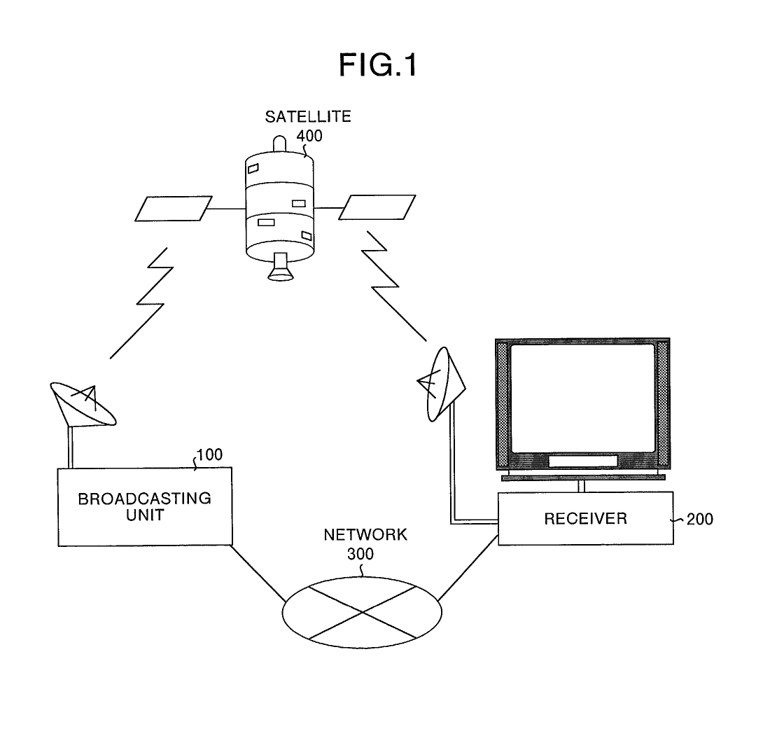

The outline of the present system is described below and then, a configuration and processing of the present system are described in detail. FIG. 1 is a block diagram showing a general configuration of the present system, in which only portions of the system configuration relating to the present invention are conceptually shown.

The present system is schematically constituted by communicably connecting the broadcasting unit 100 with the receiver 200 of a listener or sponsor through the network 300 such as an Internet or the communication satellite 400 such as a CS or BS.

This system has the following basic characteristics. That is, the program information about programs to be broadcasted and relevant information such as advertisements are provided to the receiver 200 from the broadcasting unit 100. In this case, it is permitted that the broadcasting unit 100 transmits these pieces of information through a communication satellite 400 or a network 300. The present invention is not restricted to any communication means.

Among these pieces of information, the “program information” is information-storing programs edited by a broadcasting station and the like and is constituted of a video signal and an audio signal. It is permitted that the program information uses a digital video signal and a digital audio signal compressed in accordance with a compression mode such as MPEG-2 (Moving Picture Experts Group-2) or an analog video signal and an analog audio signal in accordance with NTSC (National Television System Committee) mode or PAL (Phase Alternation by Line) mode or SECAM (Sequential Couleus Avec Memoire) mode.

Moreover, the “relevant information” is information relating to programs to be broadcasted and is constituted of at least one of text information, a video signal, and an audio signal. In this case, the relevant information includes the advertisement information and auction information about a commodity and the like displayed during a program. In this case, it is permitted to multiplex the relevant information on the program information and simultaneously transmit them or collectively transmit the relevant information separately from the program information in a time zone when any audience does not look or listen, early morning, or midnight.

In this case, it is permitted to use a program-multiplexing mode for digital broadcasting as a multiplexing mode of advertisement information and relevant information. For example, the MPEG2 system standard of ISO/IEC is used as the program-multiplexing mode of digital broadcasting.

Moreover, it is permitted to transmit advertisement information and/or relevant information by using the streaming distribution art of Internet. For example, “RealSystem G2” or “Windows Medial Technologies” is used as the streaming distribution art of Internet.

In the case of the present system constituted as described above, the broadcasting unit 100 extracts objects such as a commodity, building, person, and scene appearing in a program from broadcasted program information. Then, the broadcasting unit 100 generates relevant information such as advertisement information and auction information for the extracted objects and moreover generates the sync information for synchronizing the objects with the relevant information to store the sync information in a sync-information management table. Then, the broadcasting unit 100 transmits the program information, relevant information, and sync-information management table to the receiver 200 through the network 300 and/or communication satellite 400.

The receiver 200 receives and stores these pieces of information. Then, when outputting the program information, the unit 200 refers to corresponding sync information in the sync-information management table and when outputting an object having relevant information, outputs the relevant information at the same time. Thereby, the present system can organically combine a program and an advertisement to be broadcasted and display a relevant advertisement at the same time when providing the program.

A configuration of the present system for embodying the above basic characteristics is described below.

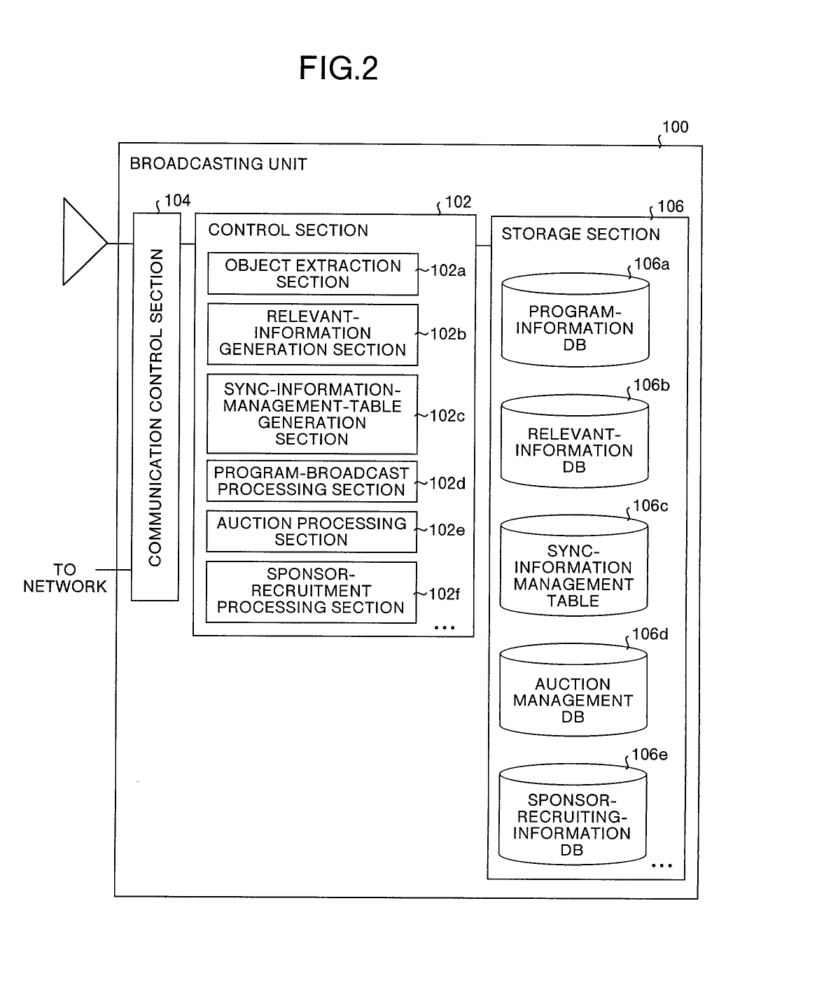

First, a configuration of the broadcasting unit 100 is described below. FIG. 2 is a block diagram showing a configuration of the broadcasting unit 100 to which the present invention is applied. FIG. 2 conceptually shows only sections of the configuration relating to the present invention. In FIG. 2, the broadcasting unit 100 is mainly constituted of a control section 102 for generally controlling the whole of the broadcasting unit 100, a communication control section 104 connected to a communication system (not shown) such as a satellite antenna or router, and a storage section 106 for storing various databases (from program-information database 106a to sponsor-recruiting-information database 106e) and these sections are connected through an optional communication line so as to be communicable each other. Moreover, the broadcasting unit 100 is communicably connected to the network 300 or communication satellite 400 through a communication system such as a router and a cable or radio communication line such as a leased line.

The databases (from program-information data base 106a to sponsor-recruiting-information database 1063e) stored in the storage section 106 use storage unit such as a fixed disk drive for storing various programs, tables, files, databases, and web-page files.

Among these components of the storage section 106, the program-information database 106a serves as a program-information storage unit which stores the program information about programs to be broadcasted to the receiver 200. The information stored in the program-information database 106a is constituted by relating a program-information identifier for univocally identifying program information, a program name, and program data including video and audio signals each other.

Moreover, the relevant-information database 106b serves as a relevant-information storage unit which stores the information about an advertisement and auction for a commodity and the like broadcasted in a program. The information stored in the relevant-information database 106b is constituted by relating a relevant-information identifier for univocally identifying relevant information, a relevant-information name, and relevant-information data including video and audio signals each other.

Furthermore, the sync-information management table 106c serves as a table for managing the sync information for synchronizing program data with relevant-information data. The sync information stored in the sync-information management table 106c is constituted by relating an object identifier for univocally identifying a commodity, building, person, or scene, the information about the time or frame in which an object appears in program data, a relevant-information identifier, and the display position of an object each other.

Furthermore, the auction-management database 106d serves as an auction-information storage unit which stores the information about auction of an object displayed in a program. The information stored in the auction-management database 106d is constituted by relating an auction-information identifier for univocally identifying auction information, an identifier of an auction participant participating in an auction, an object identifier, and a purchase price of an auction participant each other.

Furthermore, the sponsor-recruiting-information database 106e serves as a sponsor-recruiting-information storage unit which stores the information about recruitment of a sponsor for a program. The information stored in the sponsor-recruiting-information database 106e is constituted by relating a sponsor identifier for univocally identifying a sponsor, an object identifier, a relevant-information identifier, and the information about a reservation limit of an object in a contracted program each other.

Furthermore, in FIG. 2, the communication control section 104 controls the communication between the broadcasting unit 100, network 300 (or communication system such as a router) and communication satellite 400. That is, the communication control section 104 has a function of communicating data with other terminal through a cable or radio communication line.

The communication control section 104 includes an MPE-G2 encoder and a multiplexer and has satellite communication functions such as transport-stream generation, scrambling, error correction encoding, modulation, encryption, and packet transmission when performing communication with the communication satellite 400.

Moreover, in FIG. 2, the control section 102 has a control program such as an OS (Operating System), a program specifying various processing procedures, and an internal memory for storing predetermined data and performs the information processing for executing various processings by these programs and the like. The control section 102 is functionally conceptually constituted of an object extraction section 102a, a relevant-information generation section 102b, a sync-information-management-table generation section 102c, a program-broadcast processing section 102d, an auction processing section 102e, and a sponsor-recruitment processing section 102f.

Among the above sections, the object extraction section 102a serves as an object extraction unit which extracts objects such as a commodity, building, person, and scene appearing in a program from broadcasted program information. The relevant-information generation section 102b serves as a relevant-information generation unit which generates the relevant information such as advertisement information or auction information. Moreover, the sync-information-management-table generation section 102c serves as a sync-information-management-table generation unit which generates a sync-information management table for managing the sync information for synchronizing an object with relevant information. Furthermore, the program-broadcast processing section 102d serves as a program-broadcasting unit which broadcasts a program. Furthermore, an auction processing section 102e serves as auction processing unit for auctioning an object. Furthermore, the sponsor-recruitment processing section 102f serves as a sponsor-recruiting unit which recruits a sponsor of an object. Details of processings performed by these sections will be described later.

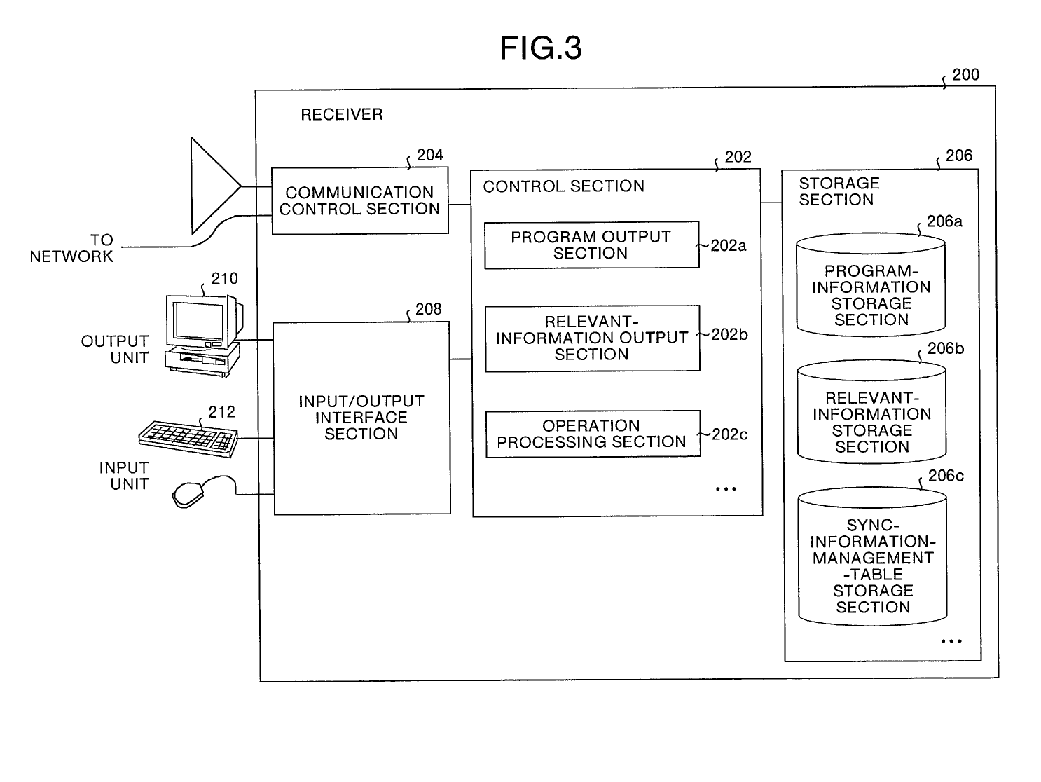

Configuration of the receiver 200 is described below. FIG. 3 is a block diagram showing a configuration of the receiver 200 to which the present invention is applied, in which only sections of the configuration relating to the present invention are conceptually shown. In FIG. 3, the receiver 200 the receiver 200 is mainly constituted of a control section 202 such as a CPU for generally controlling the whole of the receiver 200, a communication control section 204 connected to a communication system (not shown) such as a satellite antenna or router, a storage section 206 for storing various databases (from program-information storage section 206a to sync-information-management-table storage section 206c), and an input/output interface section 208 for controlling inputs/outputs connected to an output unit 210 and an input unit 212 and these sections are communicably connected each other through a communication line. Moreover, the receiver 200 is communicably connected to the network 300 or communication satellite 400 through a communication system such as a router and cable or radio communication line such as a leased line.

It is permitted to constitute the receiver 200 as a personal computer provided with an IRD (Integrated Receiver Decoder) serving as a single tuner for receiving digital broadcast, a set-top box, and a broadcast-receiving function.

The control section 202 of the receiver 200 has a control program such as an OS (Operating System), a program specifying various procedures, and an internal memory for storing predetermined data and performs information processing for executing various processings. The control section 202 is functionally conceptually constituted of a program output section 202a, a relevant-information output section 202b, and an operation processing section 202c.

Among these sections, the program output section 202a serves as a program output unit which outputs the program information transmitted from the broadcasting unit 100. Moreover, the relevant-information output section 202b serves as relevant-information output unit which outputs relevant information such as advertisement information or auction information transmitted from the broadcasting unit 100. Furthermore, the operation processing section 202c serves as an operation processing unit which performs operations such as temporary stop, playback, fast forward, and rewind. Details of processings performed by these sections will be described later.

Furthermore, it is permitted that the control section 202 is constituted of a web browser and an electronic mailer. When program information and the like are transmitted from the broadcasting unit 100 by the streaming distribution art, the control section 202 outputs program information and the like to a monitor in accordance with the function of the web browser. The web browser basically performs display control (browsing) of interpreting web data and displaying the data on a monitor to be described later. Moreover, the electronic mailer transceives electronic mails in accordance with a predetermined protocol {such as SMTP (Simple Mail Transfer Protocol)}.

The various databases (from program-information storage section 206a to sync-information-management-table storage section 206c) stored in the storage section 206 serve as storage unit such as a fixed disk drive to store various programs, files, databases, and web-page files.

Among these components of the storage section 206, the program-information storage section 206a serves as a program-information storage unit which stores the program information transmitted from the broadcasting unit 100.

Moreover, the relevant-information storage section 206b serves as a relevant-information storage unit which stores the relevant information transmitted from the broadcasting unit 100.

Furthermore, the sync-information-management-table storage section 206c serves as a sync-information-management-table storage unit which stores a sync-information management table transmitted from the broadcasting unit 100.

Furthermore, in FIG. 3, the communication control section 204 controls the communication between the receiver 200, network 300 (or a communication system such as a router), and communication satellite 400. That is, the communication control section 204 has a function of communicating data with other terminal through a cable or radio communication line.

The communication control section 204 has a function serving as a downlink station, that is, the section 204 includes a MPEG2 decoder and a multiplexer, and has satellite communication functions such as transport stream reception, descrambling, error correction, demodulation, decoding, and packet reception when performing communication with the communication satellite 400.

Moreover, the communication control section 204 controls the communication between the receiver 200 and the network 300 such as Internet (or a communication system such as a router) when performing communication with the network 300. The receiver 200 constituted as described above is connected to Internet through a communication system such as a modem, TA, or router and a telephone line or through a leased line and is able to access the broadcasting unit 100 in accordance with a predetermined protocol (such as TCP/IP Internet protocol).

Furthermore, the input/output interface section 208 has an interface function with the output unit 210 or input unit 212. The interface with the output unit 210 can use an analog RGB or digital RGB and the interface with the input unit 212 can use various serial or parallel interfaces including USB.

Furthermore, the output unit 210 can use a loudspeaker in addition to a monitor (including a household television) (the output unit is hereafter referred to as monitor).

Furthermore, the input unit 212 can use a keyboard, mouse, and microphone. The monitor also realizes a pointing-device function together with the mouse.

Configuration of the network 300 is described. The network 300 has a function of connecting the broadcasting unit 100 and receiver 200 each other such as Internet.

Configuration of the communication satellite 400 is described. The communication satellite 400 is a CS or BS and has a function of connecting the broadcasting unit 100 and the receiver 200 each other and includes a radio repeater (transponder). Moreover, the radio repeater has a function of amplifying and transmitting attenuated radio waves received from the broadcasting unit 100 and a function of converting an uplink frequency to a downlink frequency. In this case, the communication satellite 400 can use either of a geostationary satellite and a going-around satellite.

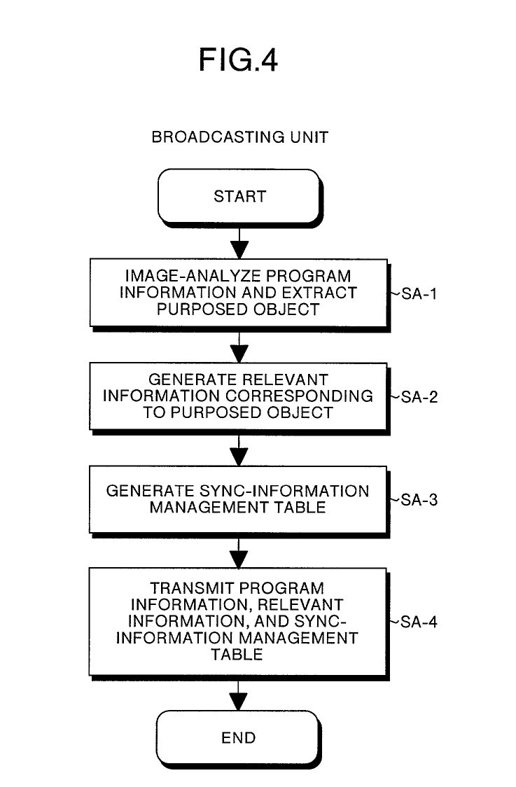

Processing by the present system of this embodiment constituted as described above is described below in detail by referring to FIGS. 4 to 19.

Details of transmission by the broadcasting unit as the present method performed by the present system thus constituted are described below by referring to FIG. 4 to FIG. 6. FIG. 4 is a flowchart showing an example of transmission by the broadcasting unit of the present system of this embodiment.

First, the broadcasting unit 100 reads program information to be broadcasted from the program information previously stored in the program-information database 106a in accordance with the control by the object extraction section 102a. Then, the object extraction section 102a image-analyzes the program information to extract objects such as a commodity, building, and scene appearing in a program and generates an object extraction table in accordance with the information of the time or frame and display position at which an object is displayed on a screen (step SA-1).

In this case, an object identifier for univocally identifying an object, the information about the time or frame at which an object is displayed in program information (such as the information about “reservation limit” to be mentioned later) and the display position of the object are recorded in the object extraction table by relating them each other.

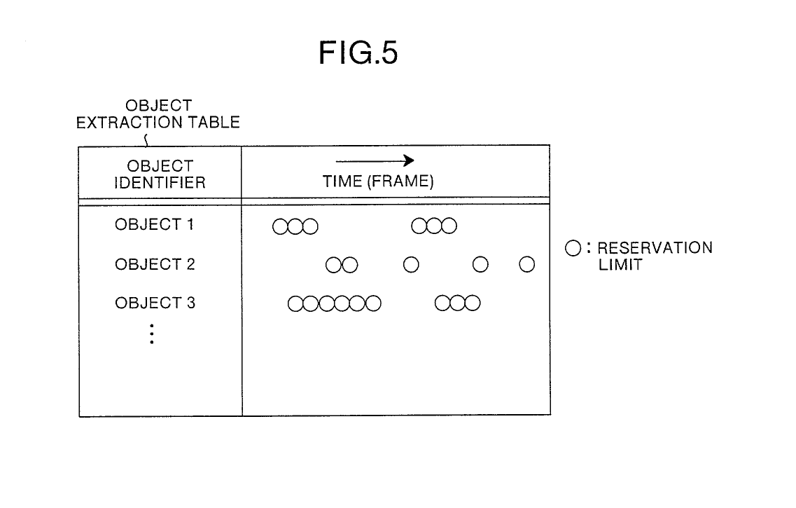

FIG. 5 is an illustration showing a concept of the object extraction table stored in the storage section 106 of the broadcasting unit 100. As shown in FIG. 5, a reservation limit is set to the object extraction table at the time (or frame) when an object appears in a program every object. In this case, “reservation limit” denotes the collective from a start frame at which an object appears up to an end frame at which the object disappears every optional unit frame. Moreover, the display position of an object is stored every frame of the reservation limit.

The broadcasting unit 100 generates the relevant information corresponding to each object in accordance with the control by the relevant-information generation section 102b and stores the information in the relevant-information database 106b (step SA-2). That is, the relevant-information generation section 102b refers to the object extraction table stored in the storage section 106 to generate the relevant information corresponding to the reservation limit of each object and stores the information in the relevant-information database 106b. In this case, the relevant information includes advertisement information for an object and auction information for auctioning the object. It is permitted for the relevant-information generation section 102b to generate relevant information by using the text information for advertisement information and auction information, video signals, or audio signals previously stored in the storage section 106.

The broadcasting unit 100 generates a sync-information management table by using the object extraction table and relevant information in accordance with the control by the sync-information-management-table generation section 102c (step SA-3). That is, the sync-information-management-table generation section 102c refers to the object extraction table and relevant-information database 106b stored in the storage section 106 to search the reservation limit of an object in which relevant information is generated, generates the sync information for synchronizing an object in a program with the relevant information, and stores the sync information in the sync-information management table 106c.

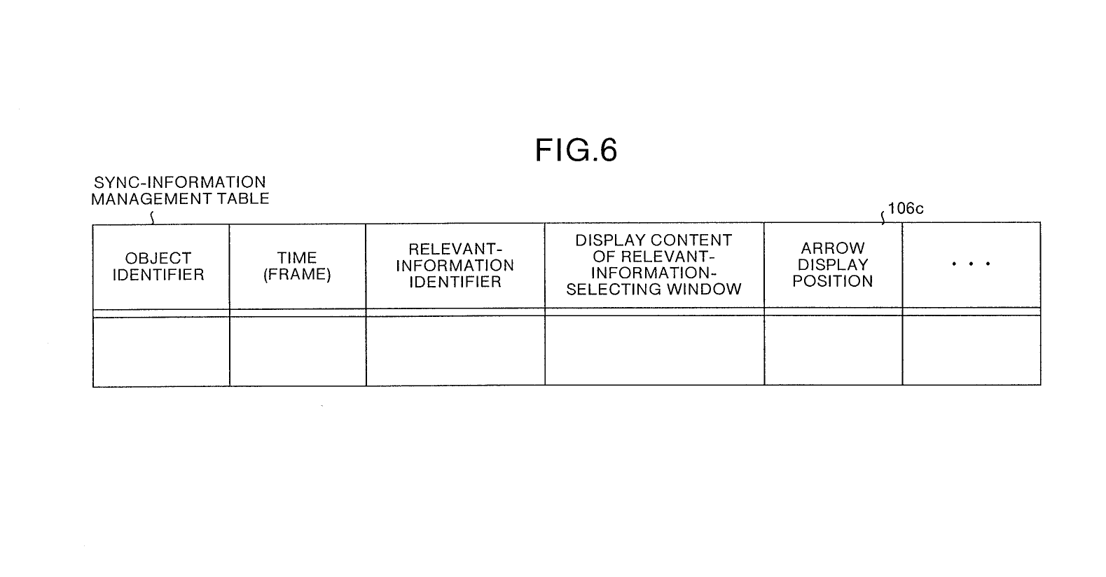

FIG. 6 is an illustration showing a concept of the sync-information management table 106c stored in the storage section 106 of the broadcasting unit 100. As shown in FIG. 6, the sync-information management table 106c stores an object identifier, the time (or frame) of reservation limit, a relevant-information identifier, contents (such as a commodity name and catch copy) displayed in a relevant-information-selecting window displayed on the monitor of the receiver 200, and the position of an arrow showing an object displayed on the monitor of the receiver 200. In this case, the sync-information-management-table generation section 102c decides a position at which an arrow for showing an object recorded in the object extraction table is displayed from the display position of each frame of the object every frame.

Then, the broadcasting unit 100 transmits the program information, relevant information, and sync-information management table stored in the storage section 106 through the network 300 and/or the communication satellite 400 in accordance with the control by the program-broadcast processing section 102d (step SA-4). That is, the program-broadcast processing section 102d accesses the program-information database 106a, relevant-information database 106b, and sync-information management table 106c to extract corresponding program information, relevant information, and a sync-information management table and transmits these extracted pieces of information through the communication control section 104. Thus, transmission by the broadcasting unit is completed.

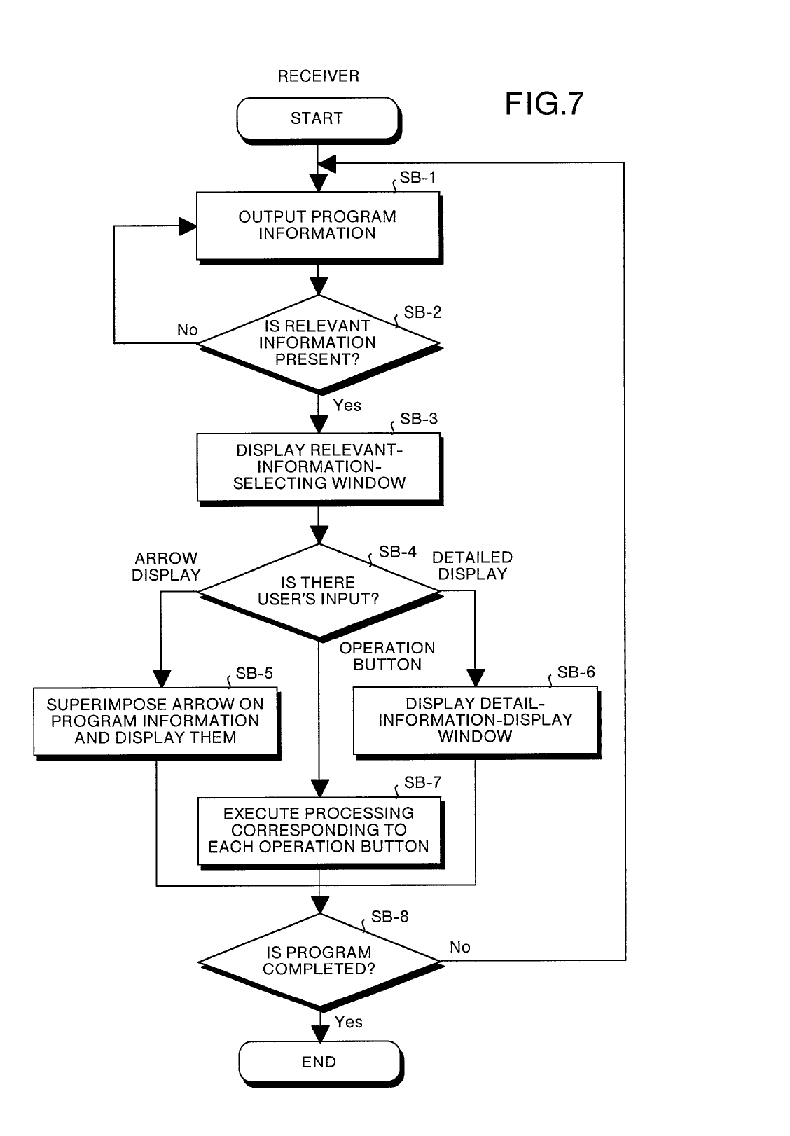

Details of output of program information and relevant information by a receiver is described below in detail by referring to FIG. 7 to FIG. 10. FIG. 7 is a flowchart showing an example of outputting of program information and relevant information by the receiver of the present system of this embodiment.

First, before staring a program, program information, relevant information, and a sync-information management table are received from the broadcasting unit 100 and are stored in the program-information storage section 206a, relevant-information storage section 206b, and sync-information-management-table storage section 206c. It is possible to use any reception sequence or reception route (such as via a satellite or Internet) of these pieces of information. That is, it is permitted that the receiver 200 receives program information through the communication satellite 400 and relevant information and a sync-information management table through the network 300.

In this case, to receive information through Internet, the receiver 200 first connects with the broadcasting unit 100 through Internet when a user designates the address (URL or the like) of a web site provided by the broadcasting unit 100 on the screen of browser software through an input unit. It is possible to realize methods for connection with and reading of a web site by a conventional art. Therefore, detailed descriptions of the methods are omitted.

The receiver 200 reads program information from the program-information storage section 206a in accordance with the control by the program output section 202a and outputs the program information to the output unit 210 (step SB-1) In this case, the relevant-information output section 202b access the sync-information management table stored in the sync-information-management-table storage section 206c to retrieve the time (or frame) at which relevant information is present in a program and determines whether relevant information is present at the time (or frame) every the time (frame) of output program information (step SB-2).

In step SB-2, when relevant information is not present, the receiver 200 outputs only program information and returns to step SB-1.

In step SB-2, however, when relevant information is present, the relevant-information output section 202b generates a relevant-information-selecting window for allowing the audience of the receiver 200 to select relevant information and displays the window on a monitor (step SB-3). That is, the relevant-information output section 202b generates a relevant-information-selecting window in accordance with the model data of a relevant-information-selecting window previously stored in the storage section 206 and “display contents of the relevant-information-selecting window” and displays the window.

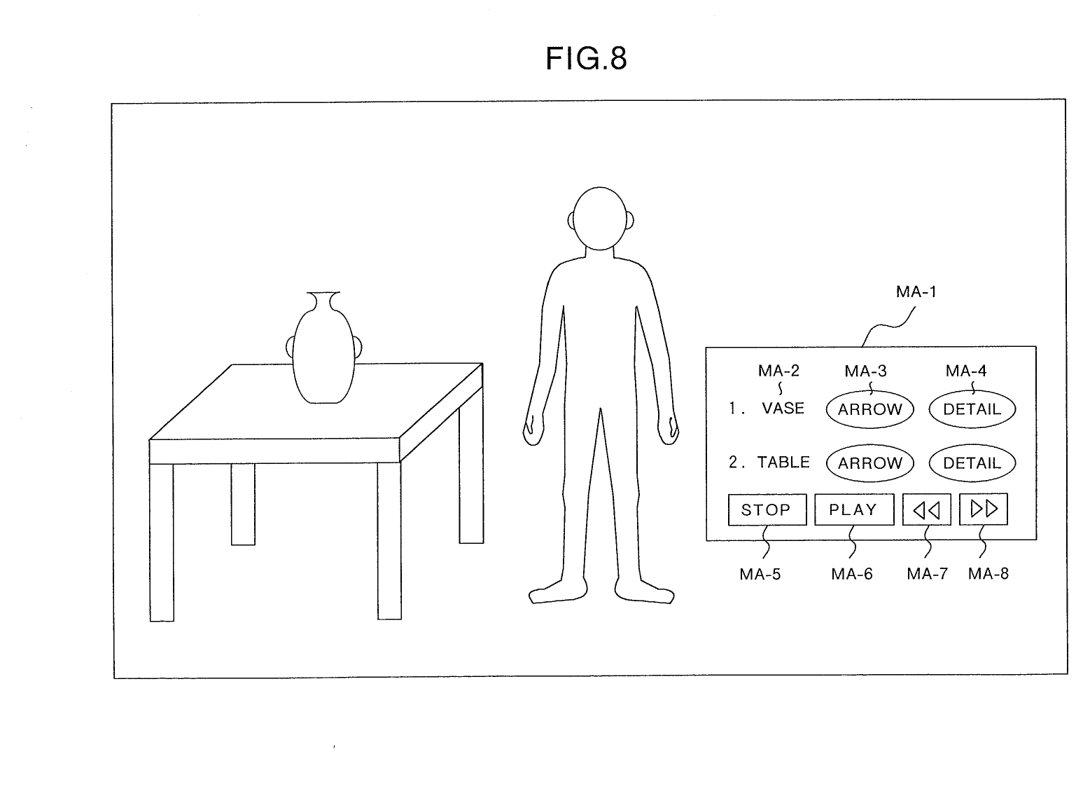

FIG. 8 is an illustration showing a display screen of a relevant-information-selecting window display on the monitor of the receiver 200. As shown by the illustration, a relevant-information-selecting window MA-1 is superimposed on program information at desired place and size while a program is broadcasted and displayed, which is constituted by including a display area MA-2 of “display contents of a relevant-information-selecting window” (e.g. object name or catch copy) of a sync-information management table, an arrow display button MA-3 for superimposing an arrow on the position shown by “arrow display position” of the sync-information management table and displaying the arrow on the output screen of program information, a detail display button MA-4 for displaying a detail-information display window for displaying the relevant information stored in the relevant-information storage section 206b, a stop button MA-5 for stopping the output of the program information and displaying a static image, a play button MA-6 for regenerating the stopped program information, a rewind button MA-7 for rewinding the program information, and a fast-forward button MA-8 for fast-forwarding the program information.

The receiver 200 determines the contents input by audience through the input unit 212 in accordance with the control by the relevant-information output section 202b (step SB-4).

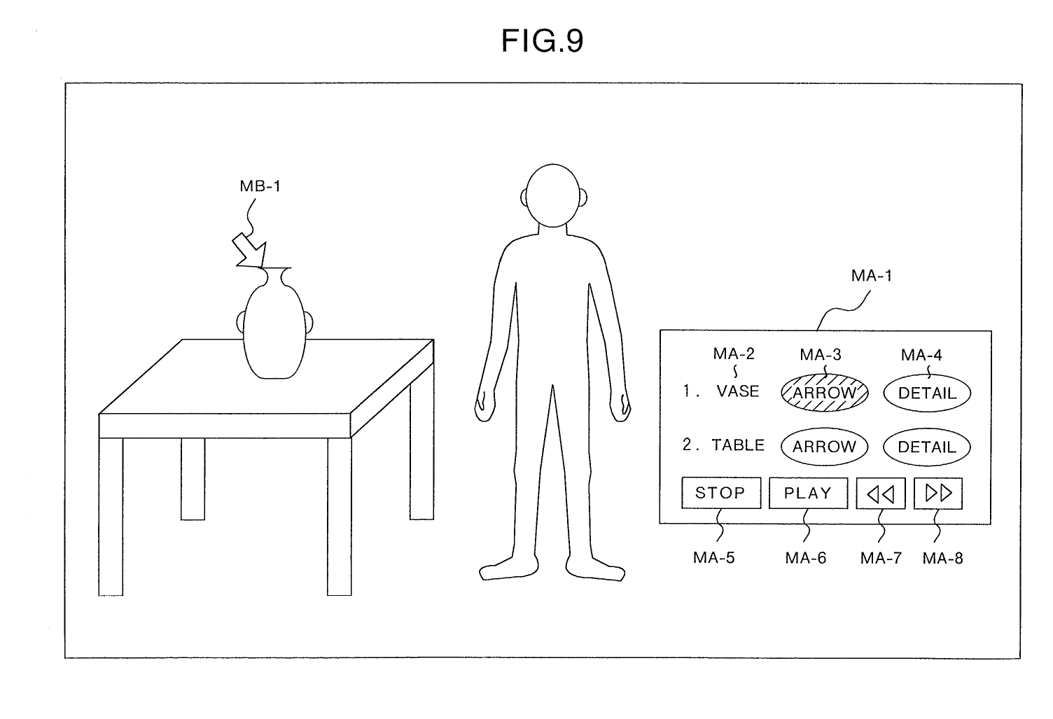

In step SB-4, when audience clicks a mouse to select the arrow display button MA-3 by the input unit 212, the relevant-information output section 202b superimposes the arrow MB-1 on the position shown by “arrow display position” of the sync-information management table and displays the arrow MB-1 on the program-information output screen as shown in FIG. 9 (step SB-5).

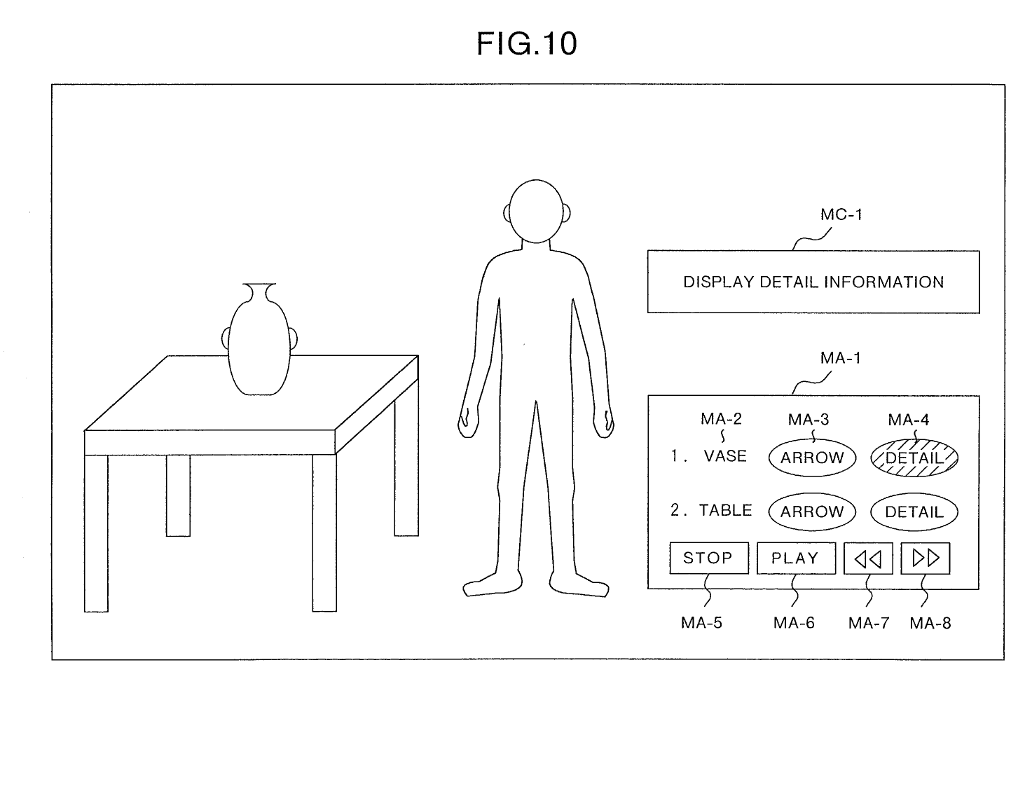

Moreover, in step SB-4, when the audience clicks the mouse to select the detail display button MA-4 by the input unit 212, the relevant-information output section 202b superimposes and displays a detail-information display window MC-1 for displaying the relevant information stored in the relevant-information storage section 206b on the program-information output screen as shown in FIG. 10 (step SB-6).

Furthermore, in step SB-4, when the audience clicks the mouse and thereby, selects one of various operation buttons (MA-5 to MA-8) by the input unit 212, the operation processing section 202c performs the processing such as temporary stop, playback, rewind, or fast forward in accordance with the designation by the selected operation button (step SB-7).

The program output section 202a determines whether the next frame is present in the program information (step SB-8). When the next frame is present, the section 202a returns to step SB-1. When the frame is not present, the section 202a completes the present processing. Thereby, outputting of the program information and relevant information by the receiver is completed.

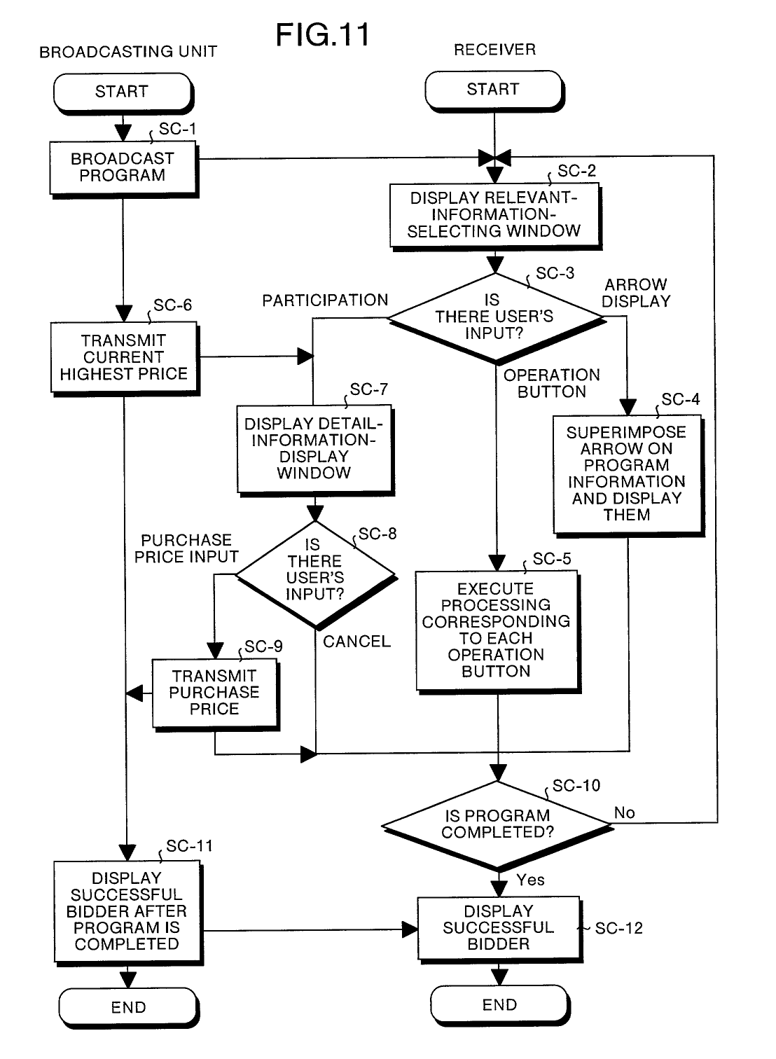

Details of the auction by the present system are described below by referring to FIG. 11 to FIG. 15. FIG. 11 is a flowchart showing an auction by the present system of this embodiment.

First, as described above, program information, relevant information, and a sync-information management table are transmitted from the broadcasting unit 100 to the receiver 200 (step SC-1).

In this case, the relevant information includes the auction information for an object displayed in a program. The receiver 200 stores received information in he program-information storage section 206a, relevant-information storage section 206b, and sync-information-management-table storage section 206c. When there is relevant information in outputting program information, the relevant-information output section 202b generates a relevant-information-selecting window for allowing the audience of the receiver 200 to select display of the relevant information and displays the window on a monitor (step SC-2). That is, the relevant-information output section 202b generates a relevant-information-selecting window in accordance with the model data of the relevant-information-selecting window previously stored in the storage section 206 and “display contents of relevant-information-selecting window” stored in the sync-information management table and displays the relevant-information-selecting window.

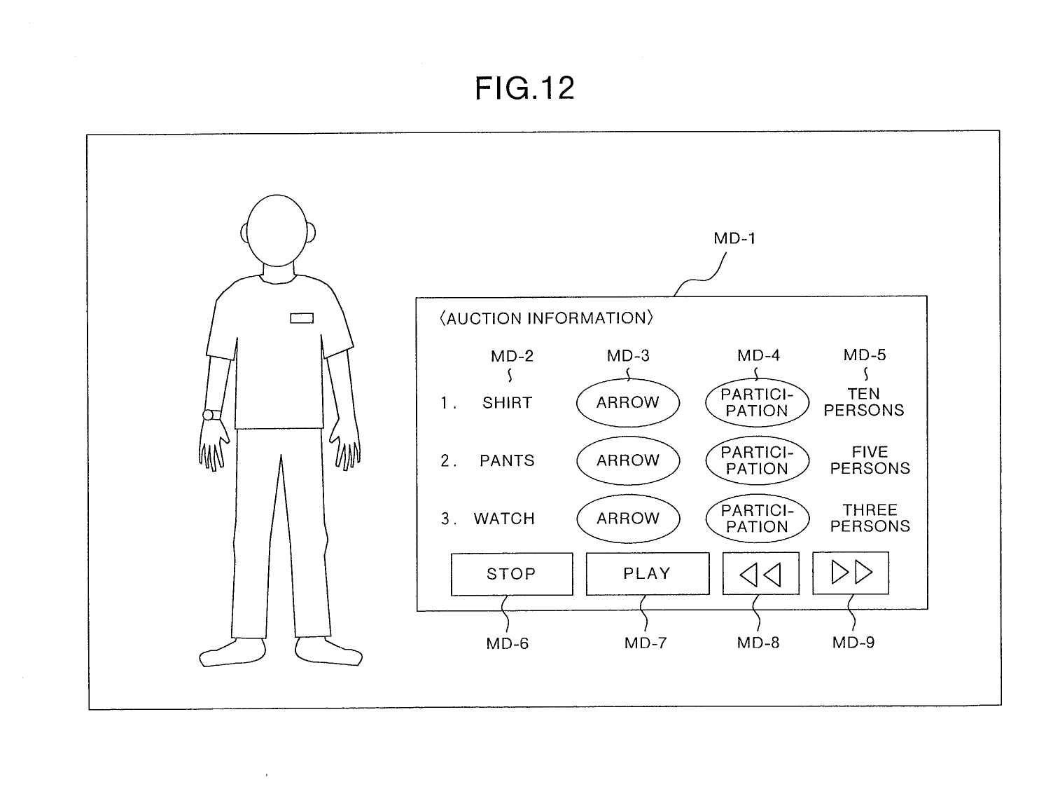

FIG. 12 is an illustration showing a display screen of a relevant-information-selecting window displayed on the monitor of the receiver 200. As shown in FIG. 12, the relevant-information-selecting window MD-1 is superimposed on program information at desired place and size and displayed while a program is broadcasted, which is constituted by including a display area MD-2 of “display contents of relevant-information-selecting window” (e.g. object name and catch copy) of a sync-information management table, an arrow display button MD-3 for superimposing an arrow at the position shown by “arrow display position” of the sync-information management table and displaying the arrow, a participation button MD-4 for displaying a detail-information-display window for displaying the relevant information stored in the relevant-information storage section 206b in order to participate in the auction for an object, a number-of-auction-participants display area MD-5, a stop button MD-6 for stopping the output of the program information and displaying a static image, a play button MD-7 for regenerating the stopped program information, a rewind button MD-8 for rewinding the program information, and a fast-forward button MD-9 for fast-forwarding the program information.

The auction processing section 102e of the broadcasting unit 100 transmits the present number of auction participants in real time and the relevant-information output section 202b of the receiver 200 displays the number of auction participants received from the broadcasting unit 100 in the number-of-auction-participants display area MD-5.

The receiver 200 determines the content input through the input unit 212 by audience in accordance with the control by the relevant-information output section 202b (step SC-3).

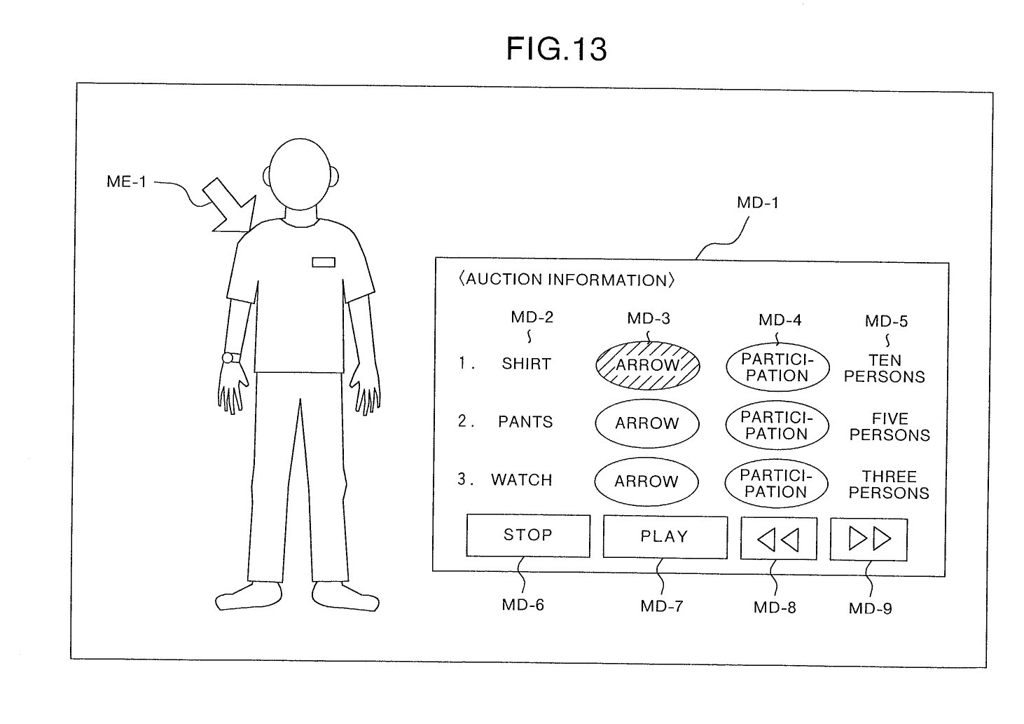

In step SC-3, when audience clicks a mouse and thereby selects the arrow display button MD-3 by the input unit 212, the relevant-information output section 202b superimposes an arrow ME-1 on the position shown by “arrow display position” of the sync-information management table and displays it on the output screen of program information as shown in FIG. 13 (step SC-4).

Moreover, in step SC-3, the audience clicks, for example, the mouse and thereby selects one of various operation buttons (MD-6 to MD-9) by the input unit 212, the operation processing section 202c performs the processing such as temporary stop, playback, rewind, or fast forward in accordance with the designation by the selected operation button (step SC-5).

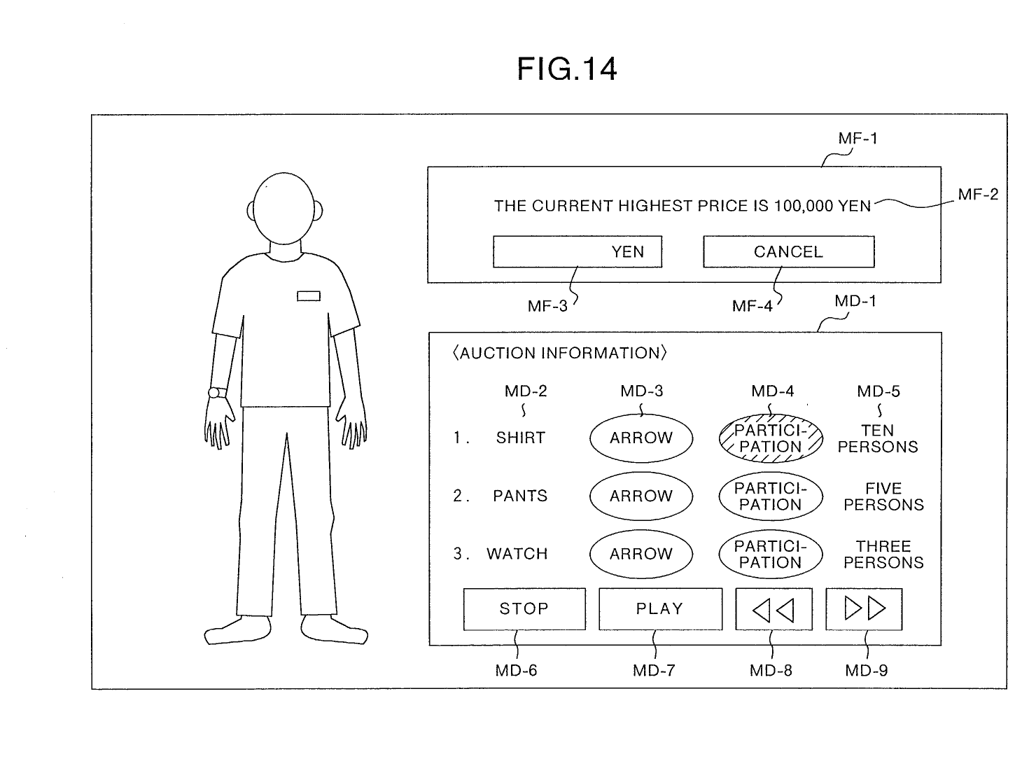

Furthermore, in step SC-3, when the audience clicks, for example, the mouse and thereby selects the participation button MD-4 by the input unit 212, the relevant-information output section 202b superimposes and displays a detail-information display window FM-1 for displaying the relevant information stored in the relevant-information storage section 206b on the output screen of program information as shown in FIG. 14 (step SC-7).

As shown in FIG. 14, the detail-information display window MF-1 is constituted by including a highest-price display area MF-2 for displaying the highest price at present, a purchase-price input area MF-3 for inputting a purchase price, and a cancel selection button MF-4 for canceling auction and closing the detail-information display window MF-1.

Moreover, the auction processing section 102e of the broadcasting unit 100 transmits the highest price among purchase prices shown by present auction participants in real time (step SC-6) and the relevant-information output section 202b of the receiver 200 displays the highest price received from the broadcasting unit 100 in the highest-price display area MF-2.

The receiver 200 determines the contents input through the input unit 212 by the audience in accordance with the control by the relevant-information output section 202b (step SC-8).

In step SC-8, when the audience inputs a desired purchase price in the purchase-price input area MF-3 by the input unit 212, the receiver 200 transmits the input purchase price and the identifier of the audience previously stored in the storage section 206 to the broadcasting unit 100 in accordance with the control by the relevant-information output section 202b (step SC-9).

When the broadcasting unit 100 receives these pieces of information, it stores the received information in the auction-management database 106d in accordance with the control by the auction processing section 102e.

Moreover, in step SC-8, when the audience clicks, for example, the mouse and thereby, selects the cancel selection button MF-4 by the input unit 212, the detail-information display window MF-1 closes and step SC-10 is started.

The program output section 202a determines whether the next frame is present in program information (step SC-10) When the frame is present, the section 202a returns to step SC-2.

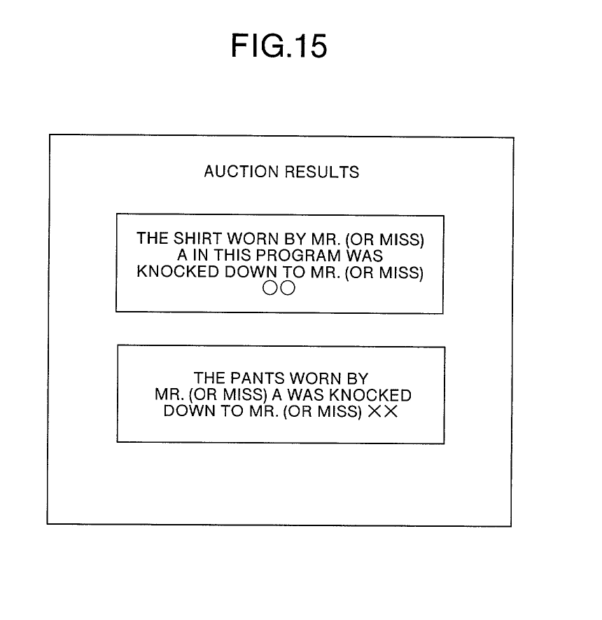

When a preset auction period is completed because program broadcasting is completed, the auction processing section 102e of the broadcasting unit 100 accesses the audition-management database 106d to retrieve the audience showing the highest price and generates a successful-bidder display screen for displaying a successful bidder to transmit the screen to the receiver 200 (step SC-11). Thereby, the successful-bidder display screen is displayed on the monitor of the broadcasting unit 100 as shown in FIG. 15. Thus, auctioning by the present system is completed.

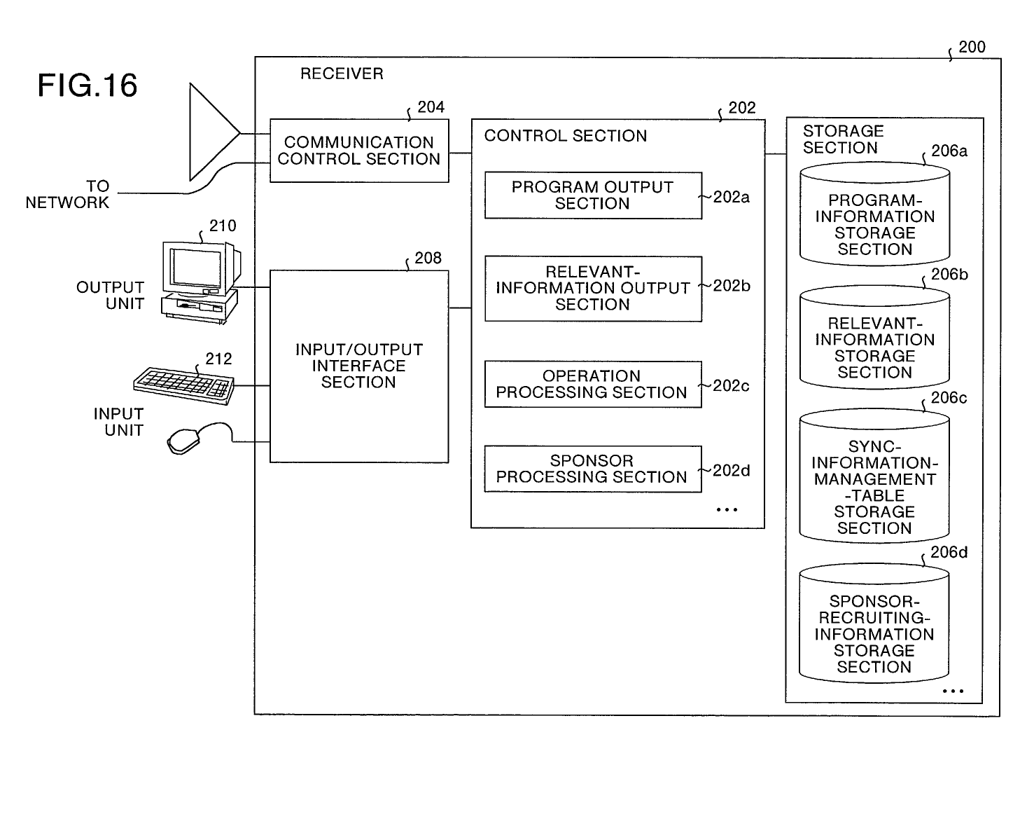

Details of the sponsor recruitment by the present system are described below by referring to FIG. 16 to FIG. 19.

This is a processing for recruiting a sponsor for the object in the above program by connecting the broadcasting unit 100 with the receiver 200 of the sponsor.

Configuration of the receiver 200 of a sponsor is described below. FIG. 16 is a block diagram showing a configuration of the receiver 200 of the sponsor to which the present invention is applied, which conceptually shows only sections of the configuration relating to the present invention. In this case, because a section provided with the same symbol as that in FIG. 3 has the same function, description of the section is omitted.

In FIG. 16, the receiver 200 is constituted by mainly including a control section 202 such as a CPU for generally controlling the whole of the receiver 200, a communication control section 204 connected to a communication system (not shown) such as a satellite antenna or router, a storage section 206 for storing various databases (from program-information storage section 206a to sponsor-recruiting-information storage section 206d), and an input/output interface section 208 connected to an output unit 210 and an input unit 212 to control inputs/outputs and these sections are communicably connected each other through an optional communication line.

In this case, the receiver 200 for audiences shown in FIG. 3 is different from that shown in FIG. 16 in that the control section 202 is further provided with a sponsor processing section 202d and the storage section 206 is further provided with a sponsor-recruiting-information storage section 206d. Details of these sections will be described later.

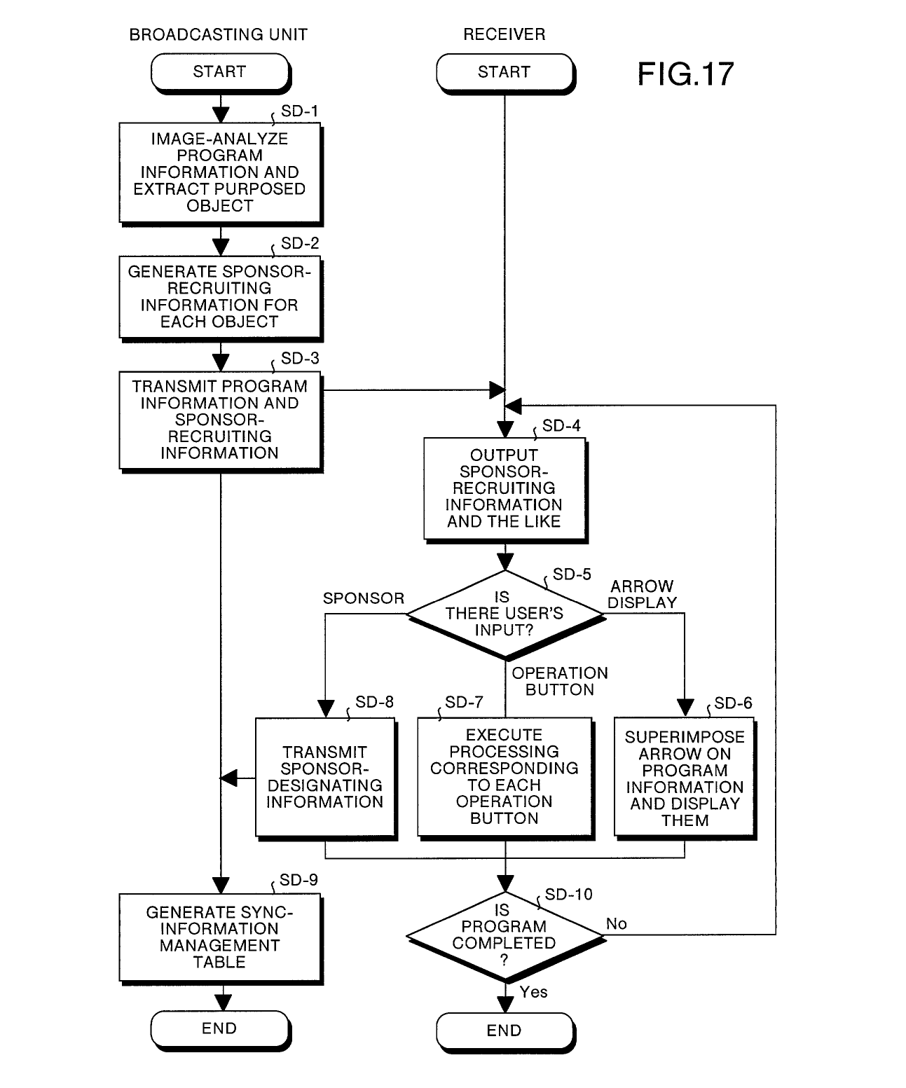

FIG. 17 is a flowchart showing sponsor recruitment by the present system of this embodiment.

First, broadcasting unit 100 reads program information to be broadcasted from the program information previously stored in a program-information database 106a in accordance with the control by an object extraction section 102a. The object extraction section 102a image-analyzes the program information to extract objects such as a commodity, building, person, and scene appearing in a program and generates an object extraction table (step SD-1).

The broadcasting unit 100 refers to the object extraction table in accordance with the control by a sponsor-recruitment processing section 102f, sets an advertisement rate every reservation limit of each object to generate sponsor-recruiting information, and stores the information in a sponsor-recruiting-information database 106e (step SD-2).

The sponsor-recruiting-information database 106e stores an object identifier, the time (or frame) of a reservation limit, a sponsor-recruiting-information identifier, an advertisement rate per reservation limit, contents (such as commodity name and catch copy) to be displayed on a sponsor-recruiting-information display window to be displayed on the monitor of the receiver 200, and the position of an arrow showing an object displayed on the monitor of the receiver 200. In this case, the sponsor-recruitment processing section 102f decides the position for displaying an arrow showing the object every frame in accordance with the display position of each frame of the object recorded in the object extraction table.

The broadcasting unit 100 extracts the program information stored in the program-information database 106a and the sponsor-recruiting information stored in the sponsor-recruiting-information database 106e and transmits these pieces of information to the receiver 200 in accordance with the control by the sponsor-recruitment processing section 102f (step SD-3).

The receiver 200 receives program information and sponsor-recruiting information from the broadcasting unit 100 in accordance with the control by the sponsor-recruitment processing section 202d and stores the former information in the program-information storage section 206a and the latter information in a sync-information-management-table storage section 206c. It is possible to use any reception sequence and reception route (such as via satellite or Internet) of these pieces of information. That is, it is permitted that the receiver 200 receives the program information through the communication satellite 400 and the sponsor-recruiting information through the network 300.

The sponsor processing section 202d outputs sponsor-recruiting information to a monitor (step SD-4). That is, when reading program information from the program-information storage section 206a and outputting the program information to the output unit 210 in accordance with the control by the program output section 202a, the sponsor processing section 202d accesses the sponsor-recruiting information stored in the sponsor-recruiting-information storage section 206d to retrieve the time (or frame) at which sponsor-recruiting information is present in a program and determines whether sponsor-recruiting information is present every the time (frame) of output program information.

When the sponsor-recruiting information is present, the sponsor processing section 202d generates a sponsor-recruiting-information display window for displaying sponsor-recruiting information for the sponsor of the receiver 200 and displays the window on a monitor (step SD-4). That is, the relevant-information output section 202b generates a sponsor-recruiting-information display window in accordance with the model data of the sponsor-recruiting-information display window previously stored in the storage section 206 and “display contents of sponsor-recruiting-information display window” stored in the sponsor-recruiting information and displays the generated window.

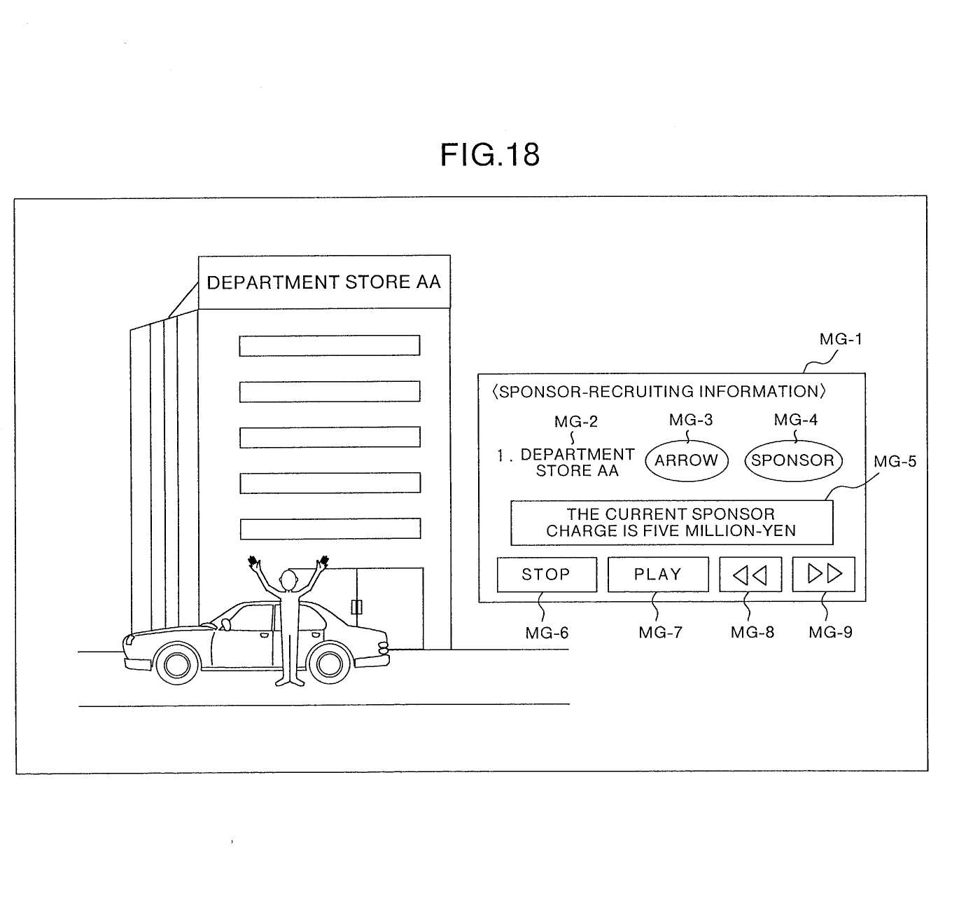

FIG. 18 is an illustration showing a sponsor-recruiting-information display window displayed on the monitor of the receiver 200. As shown in FIG. 18, the sponsor-recruiting-information display window MG-1 is superimposed on program information at desired place and size while a program is broadcasted and constituted by including, for example, a display area MG-2 of “display contents of sponsor-recruiting-information display window” (e.g. object name and catch copy) of sponsor-recruiting information, an arrow display button MG-3 for superimposing an arrow on the position shown by “arrow display position” of the sponsor information and displaying the arrow on the output screen of the program information, a sponsor designation button MG-4 for designating a sponsor to the broadcasting unit 100, an add-rate display area MG-5 for displaying “advertisement rate per reservation limit” of the sponsor-recruiting information, a stop button MG-6 for stopping the output of the program information and displaying a static image, a play button MG-7 for regenerating the stopped program information, a rewind button MG-8 for rewinding the program information, and a fast-forward button MG-9 for fast-forwarding the program information.

The broadcasting unit 200 determines the contents input by audience through the input unit 212 in accordance with the control by the sponsor processing section 202d (step SD-5)

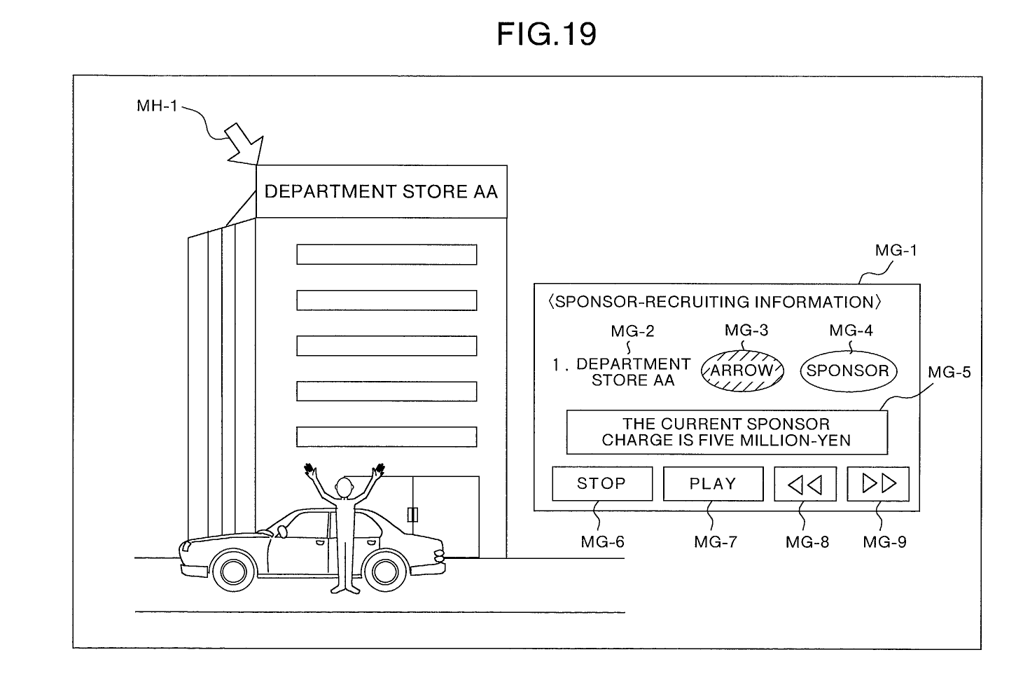

In step SD-5, when audience clicks a mouse and thereby selects the arrow display button MG-3 by the input unit 212, the sponsor processing section 202d superimposes an arrow MH-1 on the position shown by “arrow display position” of the sponsor information and displays the arrow MH-1 on the output screen of the program information as shown in FIG. 19 (step SD-6).

Moreover, in step SD-5, when the audience clicks the mouse and thereby selects one of various operation buttons (MG-6 to MG-9) by the input unit 212, the operation processing section 202c performs the processing such as temporary stop, playback, rewind, or fast forward in accordance with the designation by the selected operation button (step SD-7).

Furthermore, in step SD-5, when the audience clicks the mouse and thereby, selects the sponsor designation button MG-4 by the input unit 212, the receiver 200 transmits an object identifier, and a sponsor identifier and relevant information (advertisement information) previously stored in the storage section 206 to the broadcasting unit 100 in accordance with the designation of a sponsor in accordance with the control by the sponsor processing section 202d (step SD-7).

When receiving the above pieces of information, the broadcasting unit 100 stores the received object identifier and relevant information in the relevant-information database 106b in accordance with the control by the sponsor processing section 102f. Moreover, the equipment 100 generates a sync-information management table in accordance with the received object identifier, relevant information, and the object extraction table generated in step SD-1 and stores the sync-information management table in the storage section 106.

The sponsor processing section 202d determines whether the next frame is present in program information (step SD-10) When the next frame is present, the section 202d returns to step SD-1. When the next frame is not present, the section 202 completes the present processing. The sponsor recruitment processing by the present system is completed.

An embodiment of the present invention is described above. However, it is permitted that the present invention is executed by various different embodiments in the range of the technical idea to be described later in claims in addition to the above embodiments.

For example, it is permitted to use the numbers of frames different from each other in time zone for the “reservation limit” of the object described by referring to FIG. 5. For example, it is permitted to seta reservation limit so that the number of frames decreases in the time zone of the so-called golden time from 7:00 pm to 9:00 pm. Thereby, when levying an advertisement rate every reservation limit, it is possible that the broadcasting station side can efficiently calculate the advertisement rate.

Moreover, it is permitted to execute the sponsor recruitment processing explained by referring to FIG. 17 while a program is broadcasted. That is, a sponsor can transmit a sponsor designation in real time while viewing the audience rate of a program.

Furthermore, it is possible to manually perform all or some of processings described by assuming that they are automatically performed among the processings described for embodiments or automatically perform all or some of processings described by assuming that they are manually performed in accordance with a publicly-known method.

Furthermore, it is possible to optionally change the processing procedures, control procedures, specific names, information including parameters such as various registered data values and retrieval conditions, screen examples, and database configurations shown in the above documents and drawings unless otherwise specified.

Furthermore, illustrated components of the broadcasting unit 100 are functionally conceptual. Therefore, it is not always necessary that the equipment 100 is physically constituted as illustrated.

For example, it is possible to realize processing functions of the broadcasting unit 100, particularly all or some of the processing functions performed by the control section of the equipment 100 by a CPU (Central Processing Unit) or a program to be interpreted and executed by the CPU or realize all or some of the processing functions as hardware using a wire logic. The program is recorded in a recording medium to be described later and mechanically read by the broadcasting unit 100 according to necessity.

Moreover, it is permitted that the broadcasting unit 100 is further provided with an input unit (not shown) constituted of various pointing devices including a mouse, a keyboard, an image scanner, and a digitizer, a display unit (not shown) used to monitor input data, a clock generation section (not shown) for generating a system clock, and an output unit (not shown) such as a printer for outputting various processing results and other data as components and moreover, it is permitted that the input unit, display unit, and output unit are connected to the control section 102 through input/output interfaces.

Various databases and tables stored in the storage section 106 use a memory such as a RAM or ROM, a fixed disk driver such as a hard disk, and storage unit such as a flexible disk or optical disk for storing various programs, tables, databases, and web-page files used to perform various processings and provide a web site.

Moreover, it is permitted to realize the broadcasting unit 100 by connecting peripheral units such as a printer, monitor, and image scanner to an information processor such as an information processing terminal such as an already-known personal computer or workstation and mounting software (including programs and data) for realizing a method of the present invention on the information processor.

Furthermore, a specific dispersed or unified form of the broadcasting unit 100 is not restricted to illustrated one. It is possible to constitute the equipment 100 by physically dispersing or unifying the whole or a part of the equipment 100 in optional units corresponding to various loads. For example, it is permitted to independently constitute each database as an independent database system or realize some processings by using CGI (Common Gateway Interface).

Furthermore, it is permitted to realize the receiver 200 by connecting peripheral units such as a printer, monitor, and image scanner to an information processor such as an information terminal such as an already-known personal computer, workstation, household game unit, Internet TV, PHS terminal, portable terminal, mobile communication terminal, or PDA according to necessity and providing the software (including programs and data) for realizing a browsing function and electronic-mail function for web information to the information processor.

It is possible to realize the whole or an optional part of the control section of the receiver 200 by a CPU and a program to be interpreted and executed by the CPU. That is, a computer program for outputting an instruction to the CPU together with an OS (Operating System) to perform various processing is recorded in a ROM or HD. The computer program is executed by being loaded to a RAM to constitute the control section together with the CPU.

However, it is also permitted that the computer program is recorded in an application program server connected to the receiver 200 through an optional network or it is possible to down-load the whole or a part of the program according to necessity. Moreover, it is possible to realize the whole or a part of each control section as hardware using a wired logic or the like.

Moreover, it is possible to store a program of the present invention in a computer-readable recording medium. In this case, the “recording medium” can use an optional “portable physical medium” such as a floppy disk, photomagnetic disk, ROM, EPROM, EEPROM, CD-ROM, MO, or DVD, or an optional “fixing physical medium” such as a ROM, RAM, or HD built in various computer systems, or a “communication medium” for holding a program for a short time such as LAN, WAN, or a communication line or carrier wave for transmitting a program through a network represented by Internet.

Furthermore, “program” denotes a data processing method described in accordance with an optional language or description method and any format such as a source code or binary code can be used. “Program” is not always solely constituted but the following programs are also included: a program dispersedly constituted as a plurality of modules or libraries and a program achieving its function together with a separate program represented by an OS (Operating System). It is possible to use publicly-known constitution and procedure for specific constitution and reading procedure or an installing procedure after reading a recording medium for the units shown in the embodiments.

Furthermore, the network 300 has a function for connecting the broadcasting unit 100 and the receiver 200 each other and it is permitted for the network 300 to use anyone of Internet, Intranet, LAN (including cable and radio networks), VAN, personal computer communication network, public-telephone network (including analog and digital networks), leased line network (including analog and digital networks), CATV network, IMT receiver-2000 mode, GSM-mode or PDC/PDC-P-mode portable-line switching network/portable packet switching network, radio calling network, local radio network such as Bluetooth, PHS network, and satellite communication network such as CS, BS, or ISDB. That is, the present system can transceive various data values through any cable or radio network.

As described above in detail, according to the present invention, an object displayed onto the display screen of a program to be broadcasted is extracted from the program information about programs, the relevant information about the extracted object is generated, the sync information for synchronizing the program information with the relevant information is generated, the program information, relevant information, and sync information are transmitted to a receiver, the program information, relevant information, and sync information received from broadcasting unit are stored, and the program information and relevant information are synchronously output. Therefore, it is possible to provide a broadcasting method capable of displaying proper advertisement information for a commodity and the like appearing in a program and providing a program and simultaneously displaying a relevant advertisement by organically combining the program with the advertisement and a program for making the broadcasting unit execute the broadcasting method.

Moreover, according to the present invention, an object displayed onto the display screen of a program to be broadcasted is extracted from the program information about programs, the sponsor-recruiting information for recruiting a sponsor for the extracted object is generated, and the program information and sponsor-recruiting information are transmitted to the receiver, and the receiver stores the program information and sponsor-recruiting information received from the broadcasting unit, outputs the stored program information and sponsor-recruiting information, and transmits the sponsor-designating information for designating that the sponsor becomes a sponsor for the object to the broadcasting unit. Therefore, it is possible to provide a broadcasting method capable of efficiently recruiting a sponsor for a commodity and the like appearing in a program and a program for making broadcasting unit execute the broadcasting method.

The sync information includes the information about the time or frame at which an object is displayed and the information about the display position at which the object is displayed.

The relevant information is the advertisement information about an advertisement for an object.

The relevant information is the auction information about auction for an object.

Moreover, the broadcasting unit receives purchase prices of an object to be auctioned from a receiver and transmits the highest price among the received purchase prices to the receiver. Therefore, it is possible to auction an object (e.g. costume or small article wore by player) appearing in a program while the program is broadcasted.

The broadcasting unit decides the listener transmitting the highest price as a successful bidder of an object to be auctioned when broadcasting of program information is completed and transmits the decided successful bidder to a receiver. Therefore, it is possible to complete auction when a program is completed and broadcast a successful bidder.

Moreover, the receiver superimposes the relevant information corresponding to an object on the program information output by output unit in accordance with the information about the time or frame at which the object is displayed and outputs these pieces of information and superimposes the information for designating the display position of an object corresponding to the relevant information on the program information output by the output unit and outputs these pieces of information. Therefore, it is possible to display the relevant information at the timing when the object appears and designate the display position of the purposed object. In this case, the “information for designating the display position of an object” denotes the information showing the position of an object purposed by relevant information with an arrow or the like.

Moreover, the receiver displays the relevant-information-selection information for allowing the audience to select desired relevant information among the relevant information output synchronously with program information in accordance with stored relevant information and sync information and outputs only the relevant information selected by the audience. Therefore, the audience can select display of relevant information.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A method of broadcasting programs, executed by a broadcasting unit in a broadcasting system, said broadcasting system also including at least one receiving unit of a listener, the method comprising the steps of:
extracting an object that has been displayed onto the display screen of a program from the program information about programs;
generating the relevant information about the extracted object;
generating sync information to be used for synchronizing the program information with the relevant information; and
transmitting the program information, relevant information, and sync information to said receiving unit.

2. The method according to claim 1, wherein the sync information includes the information about the time at which the object is displayed or the frames that contain the object, and the information about the display position at which the object is displayed.

3. The method according to claim 1, wherein the relevant information is the advertisement information about advertisement of the object.

4. The method according to claim 1, wherein the relevant information is the auction information about auction of the object, and the method further comprising the steps of:
receiving purchase values of the object to be auctioned from said receiving unit; and
transmitting the highest value among the received purchase values.

5. The method according to claim 4, further comprising the steps of:
deciding the listener transmitting the highest price as a successful bidder of the object when broadcasting of the program information is completed; and
transmitting information about the successful bidder to the receiving unit.

6. A method of broadcasting programs, executed by a broadcasting unit in a broadcasting system, said broadcasting system also including at least one receiving unit of a listener, the method comprising the steps of:
extracting an object displayed onto the display screen of a program from the program information about programs;
generating the sponsor-recruiting information for recruiting a sponsor for the extracted object; and
transmitting the program information and the sponsor-recruiting information to said receiving unit.

7. A method of receiving programs, broadcast by a broadcasting unit, by a receiving unit of a listener, the method comprising the steps of:
receiving the program information about a program to be broadcasted, relevant information about an object displayed onto the display screen of the program, and sync information for synchronizing the program information with the relevant information from said broadcasting unit;
storing the received program information, relevant information, and sync information; and
synchronously outputting the program information and relevant information in accordance with the stored sync information.

8. A method of receiving programs, broadcast by a broadcasting unit, by a receiving unit of a listener, the method comprising the steps of:
receiving the program information about a program to be broadcasted and sponsor-recruiting information for recruiting a sponsor for an object displayed onto the display screen of the program;
storing the program information and sponsor-recruiting information;
outputting the stored program information and sponsor-recruiting information; and
transmitting sponsor-designating information for designating that the sponsor becomes a sponsor for the object to said broadcasting unit.

9. A computer program that contains instructions which when executed realizes a method of broadcasting programs on a broadcasting unit in a broadcasting system, said broadcasting system also including at least one receiving unit of a listener, the computer program making said broadcasting unit realize the steps of:
extracting an object that has been displayed onto the display screen of a program from the program information about programs;
generating the relevant information about the extracted object;
generating sync information to be used for synchronizing the program information with the relevant information; and
transmitting the program information, relevant information, and sync information to said receiving unit.

10. A computer program that contains instructions which when executed realizes a method of broadcasting programs on a broadcasting unit in a broadcasting system, said broadcasting system also including at least one receiving unit of a listener, the computer program making said broadcasting unit realize the steps of:
extracting an object that has been displayed onto the display screen of a program from the program information about programs;
generating a sponsor-recruiting information for recruiting a sponsor for the extracted object; and
transmitting the program information and sponsor-recruiting information to said receiving unit.

11. A computer-readable recording medium which stores a computer program that contains instructions which when executed realizes a method of broadcasting programs on a broadcasting unit in a broadcasting system, said broadcasting system also including at least one receiving unit of a listener, the computer program making said broadcasting unit realize the steps of:
extracting an object that has been displayed onto the display screen of a program from the program information about programs;
generating the relevant information about the extracted object;
generating sync information to be used for synchronizing the program information with the relevant information; and
transmitting the program information, relevant information, and sync information to said receiving unit.

12. A computer-readable recording medium which stores a computer program that contains instructions which when executed realizes a method of broadcasting programs on a broadcasting unit in a broadcasting system, said broadcasting system also including at least one receiving unit of a listener, the computer program making said broadcasting unit realize the steps of:
extracting an object that has been displayed onto the display screen of a program from the program information about programs;
generating the relevant information about the extracted object;
generating sync information to be used for synchronizing the program information with the relevant information; and
transmitting the program information, relevant information, and sync information to said receiving unit.

13. A broadcasting unit that broadcasts a program to at least one receiving unit of a listener, said broadcasting unit comprising:
an object extraction unit which extracts an object displayed onto a display screen of a program to be broadcasted from the program information about programs;
a relevant-information generation unit which generates the relevant information about the object extracted by said object extraction unit;
a sync-information generation unit which generates the sync information for synchronizing the program information with the relevant information; and
a transmission unit which transmits the program information, relevant information, and sync information to the receiving unit.

14. A broadcasting unit that broadcasts a program to at least one receiving unit of a listener, said broadcasting unit comprising:
an object extraction unit which extracts an object displayed onto the display screen of a program to be broadcasted from the program information about programs;
a sponsor-recruiting-information generation unit which generates the sponsor-recruiting information for recruiting a sponsor for the object extracted by said object extraction unit;
a transmission unit which transmits the program information and sponsor-recruiting information to the receiving unit; and
a sponsor-designating-information receiver which receives the sponsor-designating information for designating that the sponsor becomes a sponsor for the object from said receiving unit.

15. A receiving unit of a listener that receives programs, broadcast by a broadcasting unit, said receiving unit comprising:
an information receiving unit which receives the sync information for synchronizing the program information about a program to be broadcasted, relevant information about an object displayed onto the display screen of the program, and sync information for synchronizing the program information with the relevant information;
a storage unit which stores the program information, relevant information, and sync information received by said information receiving unit; and
an output unit which synchronously outputs the program information and relevant information in accordance with the sync information stored by said storage unit.

16. A receiving unit of a listener that receives programs, broadcast by a broadcasting unit, said receiving unit comprising:
a storage unit which receives the program information about a program to be broadcasted and the sponsor-recruiting information for recruiting a sponsor for an object displayed onto the display screen of the program from said broadcasting unit and stores the received information;
an output unit which outputs the program information and sponsor-recruiting information stored by said storage unit; and
a sponsor-designating-information transmission unit which transmits the sponsor-designating information for designating that the sponsor becomes a sponsor for the object to said broadcasting unit.
